(19) United States
(12) Patent Application Publication
(10) Pub. No.: US 2007/0145875 A1
(43) Pub. Date: Jun. 28, 2007

(54) Film type filter and plasma display apparatus comprising the same

(76) Inventor: Ji-Suk Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/528,991

(22) Filed: Sep. 27, 2006

(30) Foreign Application Priority Data
Dec. 24, 2005 (KR) 10-2005-0129134

(51) Int. Cl. H01K 1/30; H01J 61/40

(52) U.S. Cl. 313/110; 313/112

(57) ABSTRACT

Provided are a film type filter and having a colored base film in order to reduce double image reflection when attached to a front surface of a plasma display panel (PDP) and to reduce the weight of a plasma display apparatus including the PDP and the film type filter, and a plasma display apparatus including the same.

### CROSS-REFERENCE TO RELATED PATENT APPLICATION

This application claims the priority of Korean Patent Application No. 10-2005-0129134, filed on Dec. 24, 2005 in the Korean Intellectual Property Office, the disclosure of which is incorporated herein in its entirety by reference.

### BACKGROUND OF THE INVENTION

1. Field of the Invention

The present embodiments relate to a film type filter, and a plasma display apparatus including the same.

2. Description of the Related Art

A plasma display apparatus is a flat display device that uses a plasma display panel (PDP) and a plasma discharge to display an image. Plasma display apparatuses are considered to be the next-generation of display devices due to their good display characteristics, such as high brightness, high contrast, clear images, wide viewing angles, slim structure, and large screen size.

However, in conventional plasma display apparatuses, different refraction indexes of a front substrate and a reinforcing glass filter of a plasma display panel included in conventional plasma display apparatuses cause double image reflection. Also, the reinforcing glass filter is heavy and expensive since it must have a predetermined thickness (approximately 3 mm) to protect against external impacts. Also, the reinforcing glass filter has a very complicated structure composed of various films having differing functions, thus manufacture of the plasma display apparatus is complicated and costly.

### SUMMARY OF THE INVENTION

The present embodiments provide a film type filter which reduces double image reflection when included in a plasma display apparatus and has a reduced weight, and a plasma display apparatus including the same.

The present embodiments also provide a film type filter that is easy to manufacture while reducing manufacturing costs thereof, and a plasma display apparatus having the same.

The present embodiments also provide a film type filter whose transmissivity of visible light and color can be adjusted, and a plasma display apparatus having the same.

According to another aspect of the present embodiments, there is provided a film type filter which is attached to a front surface of a plasma display panel, the film type filter comprising a base film that is colored.

The transmissivity of visible light through the base film can be from about 40% to about 90%.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a perspective view of a film type filter according to an embodiment;

FIG. 2 is a cross-sectional view of the film type filter of FIG. 1 taken along line II-II of FIG. 1;

FIG. 3 is a cross-sectional view of a modified version of the film type filter of FIG. 2;

FIG. 4 is a cross-sectional view of a film type filter according to another embodiment;

FIG. 5 is a cross-sectional view of a film type filter according to another embodiment;

FIG. 6 is a cross-sectional view of a film type filter according to another embodiment;

FIG. 7 is an exploded perspective view of a plasma display apparatus including a film type filter, such as the film type filter shown in FIG. 1, according to an embodiment; and

FIG. 8 is a cross-sectional view of the plasma display apparatus of FIG. 7 taken along line VIII-VIII of FIG. 7.

### DETAILED DESCRIPTION OF THE INVENTION

Exemplary embodiments of a film type filter and a plasma display apparatus including the film type filter of the present embodiments will be described in detail with reference to the accompanying drawings.

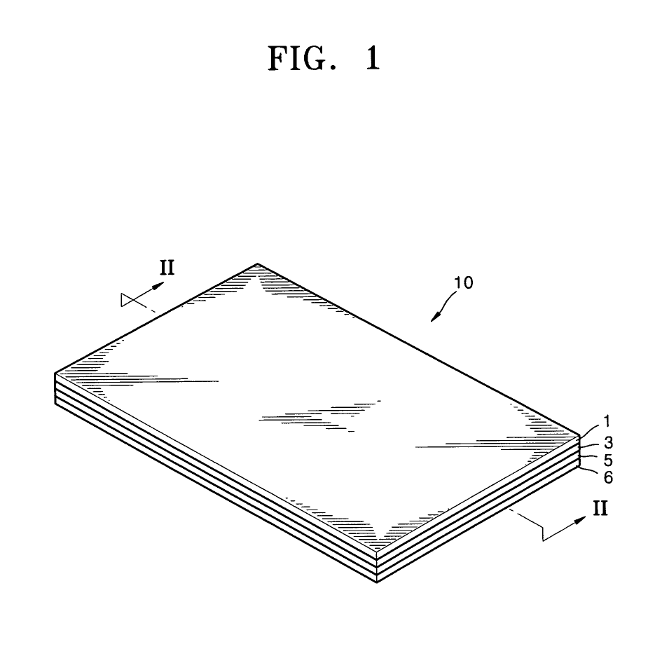

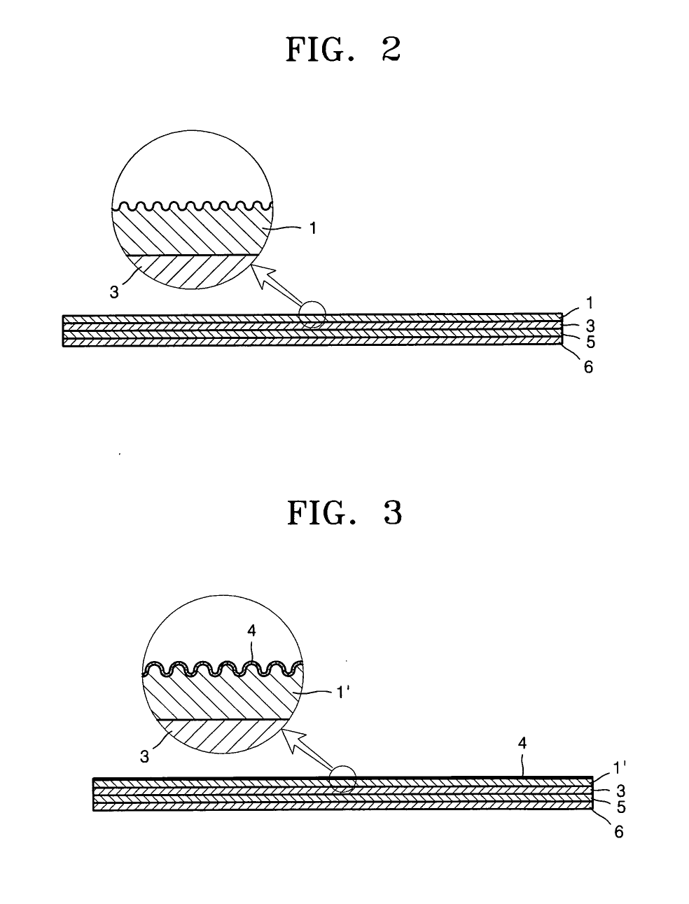

FIG. 1 is a perspective view of a film type filter 10 according to an embodiment. FIG. 2 is a cross-sectional view of the film type filter 10 taken along line II-II of FIG. 1.

Referring to FIGS. 1 and 2, the film type filter 10 includes a base film 3, an antiglare layer 1, an electromagnetic wave shielding layer 5, and an adhesive layer 6.

The base film 3 can be formed of, for example, polyethersulphone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), triacetyl cellulose (TAC), or cellulose acetate propionate (CAP), and more preferably, PC, PET, TAC, or PEN.

The base film 3 can be colored using a predetermined color. Thus, the transmissivity of visible light through the film type filter 10 may be controlled by adjusting the color of the base film 3. For example, the transmissivity of visible light can be reduced by coloring the base film 3 with a dark color. Furthermore, it is possible to adjust the color of visible light transmitted by the film type filter 10. That is, the whole color of the base film 3 may be determined such that a user feels visually comfortable with it or the degree of purity of the color of images displayed by a plasma display panel is improved. Also, the base film 3 may be patterned into a plurality of regions having different colors, which correspond to a plurality of sub pixels of the plasma display panel. However, the present embodiments are not limited to the above descriptions, and the base film 3 may be variously colored. Accordingly, the film type filter 10 having the base film 3 can be used without additional devices for adjusting the transmissivity and color of visible light through the film type filter 10, since they can be adjusted using the base film 3. Therefore, it is possible to simplify a manufacture process of a plasma display apparatus and reduce manufacturing costs thereof. The transmissivity of visible light through the colored base film 3 is preferably from about 40% to about 90%. This is because the whole brightness of the plasma display apparatus is extremely low when the transmissivity of visible light is less than about 40% and the display contrast thereof is low when the transmissivity of visible light is more than about 90%.

The base film 3 may be colored using various methods. For example, the base film 3 may be manufactured by mixing a film material, such as PET, with a pigment. The pigment may be, for example, carbon black. The pigment may also be an inorganic compound, such as an oxide containing, for example, iron, titanium, antimony, zirconium, zinc, barium, calcium, lead, chromium, molybdenum, manganese, silicon, aluminum, sodium, cobalt, or copper. Also, the pigment may be various metal oxides. For example, the pigment may be iron oxide, ammonium hexacyanoferrate (iron blue), titanium dioxide, antimony oxide, zirconium oxide, zirconium silicate, zinc oxide, zinc sulfide, barium sulfate, calcium sulfate, cadmium sulfide, cadmium selenide, lead sulfate, chrome oxide, chromate, molybdenum acid salt, manganate, silica, silicate, aluminosilicate, sodium alumino sulfosilicate, or a complex inorganic compound. Also, the pigment may be an organic pigment, such as phthalocyanine, copper phthalocyanine, quinacridone magenta, anthraquinone, perylene, perinone, dioxazine, decato pyrolro pyrol, indanthrone, benzidine, isoindoline, isoindolinone, benzimidazolone; an azo gropu, a disazo group, or a poly azo that contains a metallizing azo pigment.

The above pigments may be used individually or combinationally to obtain desired properties such as color, color tone, and absorbing profile. The pigment may be contained in a base material according to coloring or color tone. The amount of pigment added to the base material may be from about 0.02 to about 0.5% of the total weight of the base material, but the present embodiments are not limited to the above amount.

The base film 3 may have a flat plate shape and a thickness of from about 50 to about 500 μm. However, the thinner the base film 3 is, the less effective anti-lacerative properties of the plasma display panel are when the panel breaks down, and the thicker the base film 3 is, the less efficient a laminating process is. Therefore, the base film 3 may be preferably formed to a thickness of from about 80 to about 400 μm.

The antiglare layer 1 is formed on one surface of the base film 3. The antiglare layer 1 disperses external light incident on a surface thereof, and prevents images of the surroundings of the film type filter 10 from being formed due to reflection of external light on the film type filter 10. If the antiglare layer 1 is applied to a conventional reinforcing glass filter, image definition is disadvantageously reduced due to a gap between a front substrate of a plasma display panel and the conventional reinforcing glass filter. Therefore, the antiglare layer 1 cannot be applied to a conventional reinforcing glass filter. However, according to the present embodiments, since the film type filter 10 is attached directly onto the plasma display panel, image definition is only very slightly degraded, and thus, the antiglare layer 1 can be applied to the film type filter 10.

The antiglare layer 1 may be obtained by forming fine irregularities on the base film 3. More specifically, recently, a need for wide viewing angles, high-speed responses, and high resolution, i.e., plasma display panels having high image quality, has been very significantly increased. A high resolution of the plasma display can be realized by minimizing each pixel size. However, when each pixel size is reduced to obtain a high resolution of more than about 133 ppi (about 133 pixels/inch), light reaching the eyes of a user has a brightness variation, thereby causing a scintillation effect to occur when viewed by a user. This phenomenon occurs when irregularities, which are larger than each pixel of a corresponding plasma display panel, are formed on the base film 3, thus causing light emitted by a single pixel to be condensed according to a lensing effect of the irregularities or causing red, green, or blue light penetrating through an adjacent sub pixel to be mixed. Thus, the fine irregularities of the antiglare layer 1 are preferably smaller than pixels of the plasma display panel.

The antiglare layer 1 can be formed, for example, using a dip coating method, an air-knife method, a curtain coating method, or a roller coating method, a wire bar coating method, or a gravure coating method.

The antiglare layer 1 may contain a hard coating material. Since plasma display apparatuses to which the film type filter 10 is applicable are subject to various types of external forces when in use, there is a high risk of scratching to the plasma display apparatuses. Accordingly, a hard coating material is included in the antiglare layer 1 so as to prevent a plasma display apparatus applied thereto from being scratched. Alternatively, an additional hard coating material layer 4 may further be formed on an antiglare layer 1′ as illustrated in FIG. 3.

The hard coating material may include a binder, such as an acryl-based polymer, a urethane-based polymer, an epoxy-based polymer, a siloxane-based polymer, or an ultraviolet ray hardening resin such as an oligomer. A silica group filler can further be included in the hard coating material in order to increase the hardness thereof.

Also, the antiglare layer 1 preferably has a thickness of from about 2 and about 7 μm and pencil hardness of from about 2 to about 3 H, but the thickness and pencil hardness of the antiglare layer 1 according to the present embodiments are not limited.

The electromagnetic wave shielding layer 5 is formed on a surface of the base film 3 opposite to the surface which the antiglare layer 1 is formed on. The electromagnetic wave shielding layer 5 filters out electromagnetic waves, generated by the plasma display apparatus, which are harmful to humans. The electromagnetic wave shielding layer 5 is formed by stacking at least one layer of a metal or a metal oxide, and preferably, has a multilayer structure in which from about 5 to about 11 layers are stacked. Particularly, when a metal oxide layer and a metal layer are included in the electromagnetic wave shielding layer 5, the metal oxide layer can prevent oxidation or degradation of the metal layer. Also, when the electromagnetic wave shielding layer 5 is formed having a multilayer structure by stacking a plurality of layers, it is possible to not only correct the surface resistance of the electromagnetic wave shielding layer 5 but also control the transmittance of visible light.

The metal layer may be formed of, for example, palladium, copper, platinum, rhodium, aluminum, iron, cobalt, nickel, zinc, ruthenium, tungsten, tin, iridium, lead, silver, or a composite thereof.

The metal oxide layer may be formed of tin oxide, indium oxide, antimony oxide, zinc oxide, zirconium oxide, titanium oxide, magnesium oxide, silicon oxide, aluminum oxide, metal alkoxide, indium tin oxide (ITO), or antimony tin oxide (ATO).

The electromagnetic wave shielding layer 5 may be formed, for example, by sputtering, vacuum evaporation, ion plating, chemical vapor deposition (CVD), or physical vapor deposition (PVD).

The metal layer or the metal oxide layer filters out not only electromagnetic waves but also filters out near-infrared rays, thereby reducing the malfunctions of external electronic devices due to the near-infrared rays.

The shape of the electromagnetic wave shielding layer 5 is not limited to the above description. For example, the electromagnetic wave shielding layer 5 may be made in the form of a mesh by using conductive metal.

The adhesive layer 6 is formed on the electromagnetic wave shielding layer 5. The adhesive layer 6 is used to attach the film type filter 10 to the plasma display panel. The adhesive layer 6 is preferably fabricated such that the difference between the diffraction indexes of the adhesive layer 6 and the plasma display panel does not exceed a predetermined value, e.g., about 1%, in order to reduce double image reflection.

The adhesive layer 6 may include a thermoplastic resin or a UV setting resin, for example, an acrylate-based resin or a pressure sensitive adhesive (PSA). The adhesive layer 6 may be formed using a dip coating method, an air-knife method, a curtain coating method, a roller coating method, a wire bar coating method, or a gravure coating method.

The adhesive layer 6 may further include a compound that absorbs near-infrared rays. The compound may be a resin that includes copper atoms, a resin that includes a copper compound or a phosphate compound, a resin that includes a copper compound or a thio-urea derivative, a resin that includes a tungsten compound, or a cyanine group compound.

Also, the adhesive layer 6 may further include a colored material, such as a dye or a pigment, in order to filter out neon light for color correction. The colored material selectively absorbs light having a wavelength of from about 400 to about 700 nm, which corresponds to wavelengths of visible light. Particularly, when a discharge occurs in the plasma display panel, unnecessary visible light having a wavelength of approximately 585 nm is generated by neon gas which is a discharge gas. Compounds, such as a cyanine group, a squarylium group, an azomethine group, a xanthene group, an oxonol group, or an azo group, may be used to absorb the unnecessary visible light. The adhesive layer 6 includes fine particles of the colored material in a dispersed state.

The transmissivity of visible light through film type filter 10 may be about 30% or more. Also, the film type filter 10 may have a haze of about 5% or less.

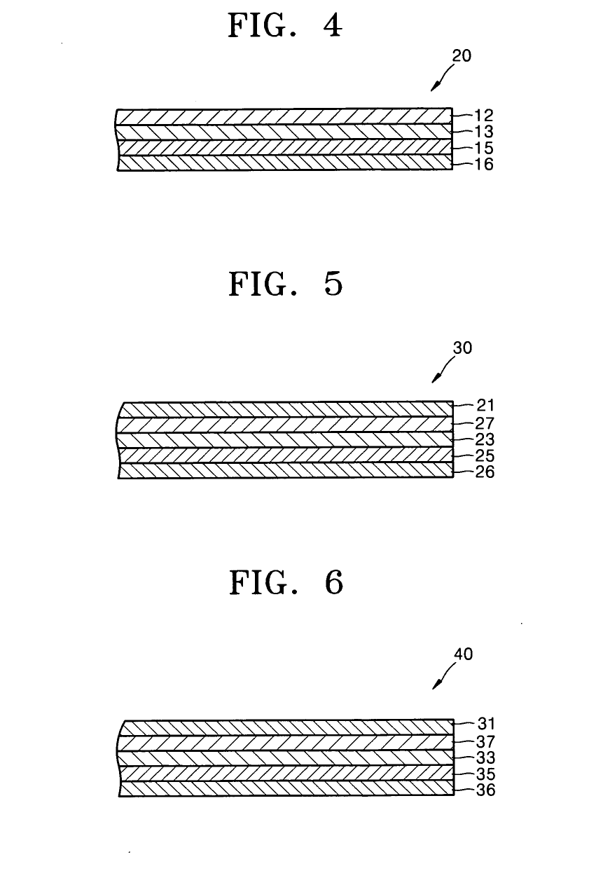

FIG. 4 is a cross-sectional view of a film type filter 20 according to another embodiment. The film type filter 20 includes a base film 13, an electromagnetic wave shielding layer 15, an anti-reflective layer 12, and an adhesive layer 16.

The base film 13 is colored to have a predetermined color. It is possible to adjust the transmissivity of visible light through the film type filter 20 by adjusting the color of the base film 13. Also, it is possible to adjust the color of visible light transmitted by the film type filter 20.

The electromagnetic wave shielding layer 15 is formed on a surface of the base film 13. The electromagnetic wave shielding layer 15 may be formed by stacking at least one layer of a metal or a metal oxide or by patterning a conductive metal to have the form of a mesh.

The adhesive layer 16 is formed on the electromagnetic wave shielding layer 15 to facilitate adhesion of the film type filter 20 to a plasma display device. The adhesive layer 16 may further contain a compound that absorbs near-infrared rays. Also, the adhesive layer 16 may further contain a colored material, such as a pigment or a dye, in order to filter out neon light for color correction.

The anti-reflective layer 12 is formed on a surface of the base film 13 opposite to the surface on which the electromagnetic wave shielding layer 15 is formed. The anti-reflective layer 12 prevents visible light incident from the outside from being reflected on the outside again. The anti-reflective layer 12 is formed by stacking layers of materials with different refractive indexes.

FIG. 5 is a cross-sectional view of a film type filter 30 according to another embodiment. The film type filter 30 includes a base film 23, an electromagnetic wave shielding layer 25, a near-infrared ray shielding layer 27, an antiglare layer 21, and an adhesive layer 26.

The base film 23 is colored to have a predetermined color. Thus, it is possible to adjust the transmissivity of visible light through the film type filter 30 by adjusting the color of the base film 23. Also, it is possible to adjust the color of visible light transmitted by the film type filter 30.

The electromagnetic wave shielding layer 25 is formed on a surface of the base film 23. The electromagnetic wave shielding layer 25 may be formed by stacking at least one layer of a metal or a metal oxide, or by patterning a conductive metal to have the form of a mesh.

The adhesive layer 26 is formed on the electromagnetic wave shielding layer 25 to facilitate adhesion of the film type filter 30 to a plasma display device. The adhesive layer 16 may further contain a colored material, such as a pigment or a dye, in order to filter out neon light for color correction.

The near-infrared ray shielding layer 27 is formed on a other surface of the base film 23 opposite to the surface on which the electromagnetic wave shielding layer 25 is formed to filter out near-infrared rays generated by the plasma display device.

The antiglare layer 21 is formed on the near-infrared ray shielding layer 27 to reduce glare. Alternatively, an anti-reflective layer may be formed instead of the antiglare layer 21.

FIG. 6 is a cross-sectional view of a film type filter 40 according to another embodiment. The film type filter 40 includes a base film 33, an electromagnetic wave shielding layer 35, a color adjusting layer 37, an antiglare layer 31, and an adhesive layer 36.

The base film 33 is colored to have a predetermined color. Thus, it is possible to adjust the transmissivity of visible light through the film type filter 40 by adjusting the color of the base film 23. Also, it is possible to adjust the color of visible light transmitted by the film type filter 40.

The electromagnetic wave shielding layer 35 is formed on a surface of the base film 33. The electromagnetic wave shielding layer 35 may be formed by stacking at least one layer of a metal or a metal oxide or by patterning a conductive metal to have the form of a mesh.

The adhesive layer 36 is formed on the electromagnetic wave shielding layer 35 to facilitate adhesion of the film type filter 40 to a plasma display device. The adhesive layer 36 may further contain a colored material, such as a pigment or a dye, in order to filter out neon light for color correction.

The color adjusting layer 37 is formed on a surface of the base film 33 opposite to the surface on which the electromagnetic wave shielding layer 35 is formed. The color adjusting layer 37 is used to adjust the degree of purity of visible light emitted from the plasma display device, or color temperature.

The antiglare layer 31 is formed on the color adjusting layer 37 to reduce glare. Alternatively, an anti-reflective layer may be formed instead of the antiglare layer 31.

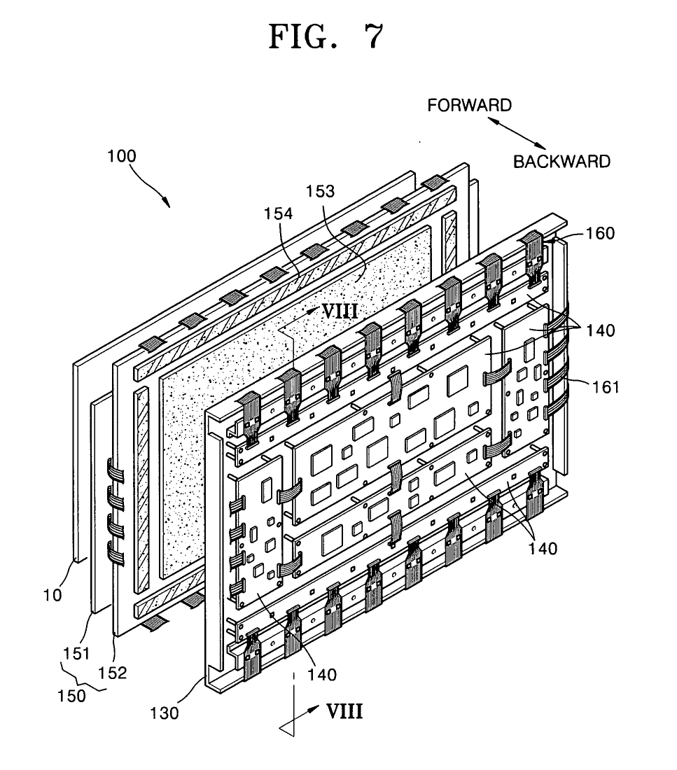

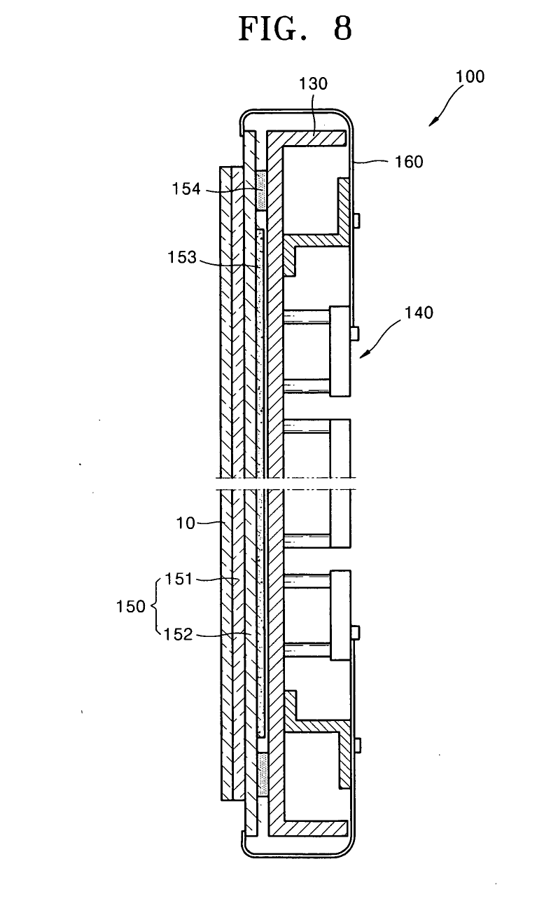

FIGS. 7 and 8 illustrate a plasma display apparatus 100 including the film type filter 10 of FIG. 1, according to an embodiment. In detail, FIG. 7 is an exploded perspective view of the plasma display apparatus 100, and FIG. 8 is a cross-sectional view of the plasma display apparatus 100 taken along line VIII-VIII of FIG. 7. In describing the plasma display panel 100, like elements recited in the aforementioned embodiments will be described with like reference numerals.

The plasma display apparatus 100 includes a film type filter 10, a plasma display panel 150, a chassis 130, a thermal conductive member 153, a plurality of double-faced adhesive tapes 154, and a plurality of circuit units 140.

The plasma display panel 150 displays images using gas discharge, and includes a front panel 151 and a rear panel 152 coupled to each other.

The film type filter 10 is attached onto a front surface of the plasma display panel 150 using the adhesive layer 6 illustrated in FIG. 1. However, the plasma display apparatus 100 of the present embodiments is not limited to the embodiment including the film type filter 10. For example, any of the film type filters 20 through 40 illustrated in FIGS. 4 through 6 can be included in the plasma display apparatus 100 according to embodiments.

The film type filter 10 filters out electromagnetic waves generated from the plasma display panel 150, and reduces glare. Also, the film type filter 10 can filter out infrared rays or neon light. Furthermore, the double image reflection problem can be fundamentally solved since the film type filter 10 is attached directly onto the front surface of the plasma display panel 150.

The film type filter 10 is lighter and less expensive to manufacture than a conventional reinforcing glass filter.

The chassis 130 is located on the rear of the plasma display panel 150 to structurally support the plasma display panel 150. The chassis 130 may be formed of a metal having high strength, such as aluminum or iron, or a plastic.

The thermal conductive member 153 is located between the plasma display panel 150 and the chassis 130. Also, the dual-faced adhesive tapes 154 are located on lateral portions of a rear surface of the plasma display panel 150 beside edges of the thermal conductive member 153 in order to fix the plasma display panel 150 and the chassis 130 together.

The plurality of circuit units 140 are located at the rear of the chassis 130, and include circuits for driving the plasma display panel 150. The circuit units 140 transmit electrical signals to the plasma display panel 150 via signal transfer units. The signal transfer units may be flexible printed cables (FPCs), tape carrier packages (TCP), or chip-on-films (COF). According to the current embodiment a plurality of FPCs 161 acting as signal transfer units are located on the left and right sides of the chassis 130, and a plurality of TCPs 160 acting as signal transfer units are located on the upper and lower sides of the chassis 130.

A film type filter according to the present embodiments and a plasma display apparatus including the same have the following advantages.

First, it is possible to reduce double image reflection since the film type filter can be attached directly to the front surface of a display panel.

Second, the film type filter is manufactured using a relatively thin base film, thereby reducing the weight and manufacturing costs thereof Further, transmissivity of light through the film type filter can be improved.

Third, it is possible to easily manufacture the film type filter by stacking layers having various functions on the base film.

Fourth, anti-glare can be improved due to the diffuse reflection effect of an antiglare layer, and specular reflection can be reduced to improve visibility.

Fifth, additional devices for adjusting the transmissivity and color of visible light transmitted by the film type filter are not needed since they can be adjusted using a colored base film, thereby simplifying manufacturing and reducing manufacturing costs.

While these embodiments have been particularly shown and described with reference to exemplary embodiments thereof, it will be understood by those skilled in the art that various changes in form and details may be made therein without departing from the spirit and scope of the embodiments as defined by the appended claims.

What is claimed is:

1. A film type filter configured to be attached to a front surface of a plasma display panel, the film type filter comprising a base film that is colored.

2. The film type filter of claim 1, wherein the transmissivity of visible light through the base film is from about 40 to about 90%.

3. The film type filter of claim 1, further comprising an antiglare layer formed on a surface of the base film.

4. The film type filter of claim 3, wherein the antiglare layer comprises a hard coating material.

5. The film type filter of claim 3, further comprising a hard coating layer formed on the anti-glare layer.

6. The film type filter of claim 1, further comprising an electromagnetic wave shielding layer formed on the surface of the base film.

7. The film type filter of claim 1, further comprising an adhesive layer formed on the surface of the base film, the adhesive layer configured to facilitate adhesion of the film type filter to the plasma display panel.

8. The film type filter of claim 1, further comprising a near-infrared ray shielding layer formed on a surface of the base film.

9. The film type filter of claim 1, further comprising an anti-reflective layer formed on a surface of the base film.

10. The film type filter of claim 1, further comprising a color adjusting layer formed on a surface of the base film.

11. The film type filter of claim 1, further comprising:
an electromagnetic wave shielding layer formed on a surface of the base film;
an adhesive layer formed on a surface of the electromagnetic wave shielding layer configured to facilitate adhesion of the film type filter to the plasma display panel; and
an antiglare layer or an anti-reflective layer formed on another surface of the base film.

12. A plasma display apparatus having a film type filter of claim 1.

13. A plasma display apparatus having a film type filter of claim 2.

14. A plasma display apparatus having a film type filter of claim 3.

15. A plasma display apparatus having a film type filter of claim 4.

16. A plasma display apparatus having a film type filter of claim 5.

17. A plasma display apparatus having a film type filter of claim 6.

18. A plasma display apparatus having a film type filter of claim 7.

19. A plasma display apparatus having a film type filter of claim 8.

20. A plasma display apparatus having a film type filter of claim 9.

21. A plasma display apparatus having a film type filter of claim 10.

22. A plasma display apparatus having a film type filter of claim 11.
